(19) United States
(12) Patent Application Publication
(10) Pub. No.: US 2024/0346871 A1
(43) Pub. Date: Oct. 17, 2024

(54) PROCESSING OF BANKNOTE

(71) Applicant: Glory Ltd., Himeji (JP)

(72) Inventor: Ayuko MIKI, Himeji (JP)

(73) Assignee: Glory Ltd., Himeji (JP)

(21) Appl. No.: 18/133,536

(22) Filed: Apr. 12, 2023

(51) Int. Cl. G07D 11/34; G07D 7/0047; G07D 11/14

(52) U.S. Cl. CPC G07D 11/34; G07D 7/0047; G07D 11/14; G07D 11/13; G07D 2207/00; G07D 2211/00

(57) ABSTRACT

A method for processing banknote includes: conveying, by a conveyor, the banknote taken in from an intake port; discriminating, by a discrimination sensor, whether the banknote conveyed by the conveyor is first banknote or second banknote, the first banknote being to be stored in at least one storage, the second banknote being to be forcibly stored in the at least one storage; and performing, by a controller, output processing to output forcible storage information used in forcible storage of the second banknote, the forcible storage information being output without user intervention.

### BACKGROUND

The present disclosure relates to processing of a banknote.

Banknotes that cannot be accepted by a banknote processing device are sometimes forcibly stored in a storage unit.

### SUMMARY

According to an embodiment of the present disclosure, there is provided a method for processing banknote. The method includes: conveying, by a conveyor, the banknote taken in from an intake port; discriminating, by a discrimination sensor, whether the banknote conveyed by the conveyor is first banknote or second banknote, the first banknote being to be stored in at least one storage, the second banknote being to be forcibly stored in the at least one storage; and performing, by a controller, output processing to output forcible storage information used in forcible storage of the second banknote, the forcible storage information being output without user intervention.

According to another embodiment of the present disclosure, there is provided an apparatus for processing banknote. The apparatus includes: a conveyor for conveying the banknote taken in from an intake port; a discrimination sensor for discriminating whether the banknote conveyed by the conveyor is first banknote or second banknote, the first banknote being to be stored in at least one storage, the second banknote being to be forcibly stored in the at least one storage; and a controller for performing output processing to output forcible storage information used in forcible storage of the second banknote, the forcible storage information being output without user intervention.

### BRIEF DESCRIPTION OF THE DRAWINGS

FIG. 1 is a perspective view of an example appearance of a banknote processing device in the first exemplary embodiment.

FIG. 2 is a side view of an example configuration of the banknote processing device in the first exemplary embodiment.

FIG. 3 is a flowchart showing an example of a setting operation of the banknote processing device in the first exemplary embodiment.

FIG. 4A shows an example of a suspicious banknote reception mode selection screen, and FIG. 4B shows an example of a deposit method selection screen.

FIGS. 5A and 5B are flowcharts showing an example of a storage operation of the banknote processing device in the first exemplary embodiment.

FIG. 6 is a front view of an example configuration of a currency processing system in the second exemplary embodiment.

FIG. 7 is a side view of an example configuration of a banknote processing device in the second exemplary embodiment.

FIG. 8 is a flowchart showing an example of a storage operation of the banknote processing device in the second exemplary embodiment.

FIG. 9 is a flowchart showing an example of a storage operation of the banknote processing device in the second exemplary embodiment.

FIG. 10 is a flowchart showing an example of a storage operation of the banknote processing device in the second exemplary embodiment.

### DETAILED DESCRIPTION

Hereinafter, exemplary embodiments of the present disclosure will be described in detail with reference to the attached drawings.

It is to be noted that the present disclosure is not limited to these exemplary embodiments to be given below and may be implemented with various modifications within the scope of the present disclosure. In addition, the drawings used herein are for purposes of illustration, and may not show actual dimensions.

The term “banknote” is used herein to denote paper currency issued by a government or a bank. Paper currency may also be referred to as “bank bill” or simply “bill,” but will be referred to as “banknote” in the following. The term “true banknote” is used to indicate a banknote that is not soiled or damaged to the extent that it is rejected by a banknote processing device, nor is of doubtful authenticity. The term “damaged banknote” is used to indicate a banknote that is soiled, damaged, etc. to the extent that it is rejected by the banknote processing device, i.e., a banknote in a worse state than the “true banknote”. The term “suspicious banknote” is used to indicate a banknote of doubtful authenticity, i.e., a banknote that is potentially a counterfeit banknote.

Further, the term “normal storage” is used herein to indicate a storage manner in which banknotes that are usually to be stored are stored, but banknotes that are usually not to be stored are not stored. On the other hand, the term “forcible storage” is used to indicate a storage manner in which banknotes that are usually not to be stored are forcibly stored in addition to banknotes that are usually to be stored.

### First Exemplary Embodiment

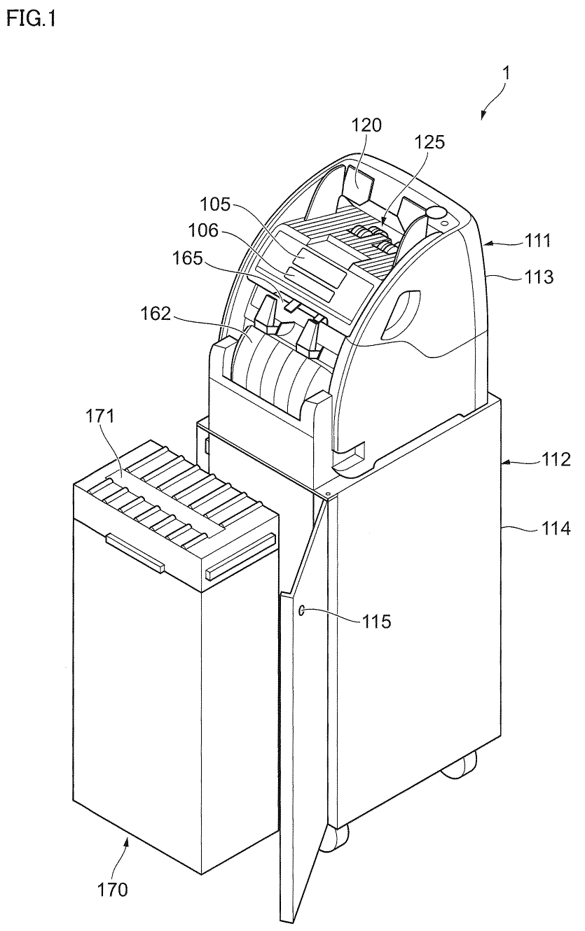

FIG. 1 is a perspective view of an example appearance of a banknote processing device 1 in the first exemplary embodiment. The banknote processing device 1 serves as one example of the claimed apparatus for processing banknote. As shown in FIG. 1, the banknote processing device 1 may include an upper processing part 111 and a lower safe box part 112.

The processing part 111 may be composed of an upper housing 113. The upper housing 113 may be provided with a display input unit 105 and a printer 106. The display input unit 105 may have a function to display predetermined information and a function to enable data input. The printer 106 may have a function to print predetermined information. Although the printer 106 is built into the banknote processing device 1 in the figure, it may be placed as an optional device by connecting it to the banknote processing device 1 with a cable at a distance from the banknote processing device 1.

The upper housing 113 may also be provided with a deposit unit 120 and an intake unit 125. The deposit unit 120 may be loaded with banknotes that a user wishes to deposit, and the intake unit 125 may take the banknotes loaded in the deposit unit 120.

The upper housing 113 may also be provided with a front shutter 162. The front shutter 162 may be a shutter for opening and closing the front opening 161 of the first stacking unit 160 (not shown) described below. In the figure, the front shutter 162 is shown closed. The upper housing 113 may also be provided with a second stacking unit 165 in addition to the first stacking unit 160.

The safe box part 112 may be composed of a safe box housing 114. The safe box housing 114 may be lockable by a locking member 115, and a storage unit 170 may be removably arranged inside the safe box housing 114. The storage unit 170 may be provided with a slit opening 171 for taking in banknotes.

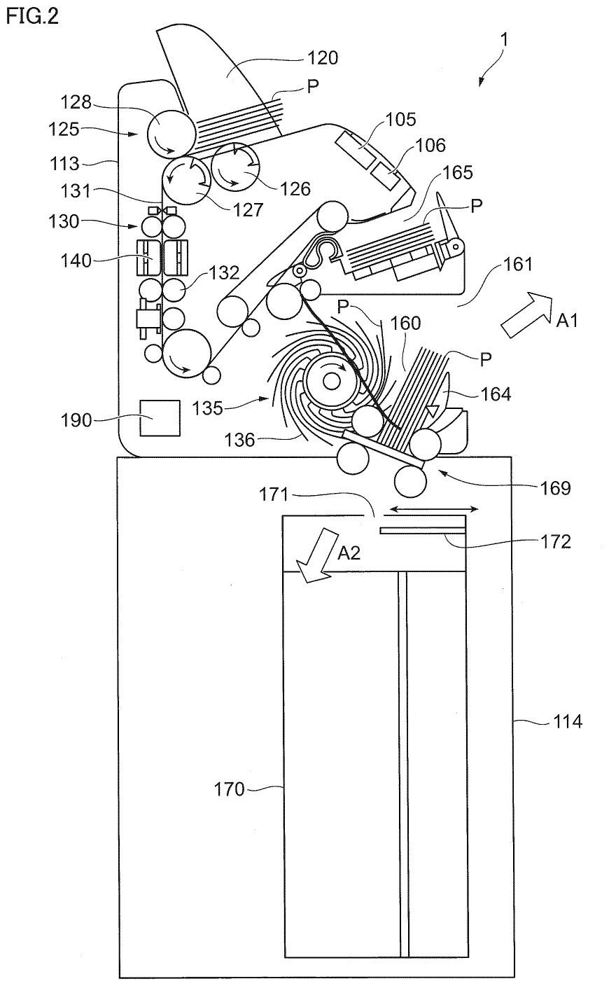

FIG. 2 is a side view of an example configuration of the banknote processing device 1 in the first exemplary embodiment. As shown in FIG. 2, the upper housing 113 may be provided with the deposit unit 120, the intake unit 125, a conveyance unit 130, a discrimination sensor 140, the first stacking unit 160, and the second stacking unit 165.

Plural banknotes P may be placed on the deposit unit 120.

The intake unit 125 may take in the plural banknotes P placed on the deposit unit 120 one by one. Specifically, the intake unit 125 may include a kicker roller 126 that provides driving force to the banknote P in the lowest position of the plural banknotes P placed on the deposit unit 120. The intake unit 125 may include, downstream of the kicker roller 126 in the direction of the banknote P ejection, a feed roller 127 that ejects the banknote P kicked out by the kicker roller 126 into the inside of the upper housing 113. A gate roller 128 may be provided facing the feed roller 127, and a gate may be formed between the feed roller 127 and the gate roller 128. The intake unit 125 serves as one example of the claimed intake port.

The conveyance unit 130 may convey the banknotes P taken in by the intake unit 125. Specifically, the conveyance unit 130 may be composed of conveyance belts 131, conveyance rollers 132, etc. that convey the banknotes P. At the downstream end of the conveyance unit 130 and near the first stacking unit 160, the conveyance unit 130 may be provided with an impeller 135 that receives the banknotes P conveyed by the conveyance unit 130 one by one between vanes 136 to stack and align them in the first stacking unit 160. The conveyance unit 130 serves as one example of the claimed conveyor for conveying the banknote taken in from the intake port.

The discrimination sensor 140 may be provided on the conveyance unit 130 and may discriminate and count the banknotes P conveyed by conveyance unit 130. Specifically, the discrimination sensor 140 may discriminate the denomination, authenticity, etc. of each of the banknotes P taken in by the intake unit 125 and conveyed by the conveyance unit 130. In this exemplary embodiment, the discrimination sensor 140 may discriminate whether the banknote P conveyed by the conveyance unit 130 is the first banknote or the second banknote. The first banknote may be the true banknote. The second banknote may be the suspicious banknote excluding the damaged banknote, or both the damaged banknote and the suspicious banknote. In addition, the discrimination sensor 140 may discriminate whether the banknote P conveyed by the conveyance unit 130 is the damaged banknote or the suspicious banknote when discriminating the banknote as the second banknote.

The first stacking unit 160 may stack the banknotes P conveyed by the conveyance unit 130. Specifically, the first stacking unit 160 may be configured to stack the banknotes P conveyed by the conveyance unit 130 by supporting the banknotes P with the support member 164, so that the banknotes P are inclined to the front side. Note that “front side” herein means the side where the operator places the banknote P on the deposit unit 120 or removes the banknote P from the first stacking unit 160 via the front opening 161 described below, i.e., the right side of FIG. 2. On the other hand, “rear side” herein means the side opposite the front side, i.e., the left side of FIG. 2.

On the front side of the first stacking unit 160, a front opening 161 for taking out the stacked banknotes P from the outside and a front shutter 162 (see FIG. 1) for opening and closing the front opening 161 may be provided. The user may take out the banknotes P through the front opening 161, which has been opened by the front shutter 162 (see arrow A1 in FIG. 2). The front shutter 162 may be controlled by the control unit 190 described below so that it cannot be opened at least when the banknote P is being transported to the storage unit 170.

The first stacking unit 160 may be provided with a clamping and transporting mechanism 169. The clamping and transporting mechanism 169 may store the banknotes P in the storage unit 170 by clamping the surface of the banknotes P stacked in the first stacking unit 160 and transporting the banknotes P in a direction parallel to the surface of the banknotes P. More specifically, the clamping and transporting unit 160 may be configured to clamp the surface of the banknote P located on the most front side and the surface of the banknote P located on the most rear side (the surface of the banknote P located on the most outer side). The clamping and transporting mechanism 169 may then be configured to transport the banknotes P collectively to the storage unit 170 (see arrow A2 in FIG. 2).

In this exemplary embodiment, in the processing in the case where the user first puts in one or more banknotes P from the deposit unit 120 (hereinafter referred to as “the first-stage processing”), the first stacking unit 160 may stack banknotes P each discriminated as the first banknote by the discrimination sensor 140. The banknotes P each discriminated as the first banknote may then be stored in the storage unit 170 by the clamping and transporting mechanism 169. The user can also deposit from the deposit unit 120 the banknotes P each discriminated as the second banknote by the discrimination sensor 140 and stacked in the second stacking unit 165 as described below. In the processing in this case (hereinafter referred to as “the second-stage processing”), the banknotes P each discriminated as the suspicious banknote by the discrimination sensor 140 may be stacked in the first stacking unit 160. The banknotes P each discriminated as the suspicious banknote may be forcibly stored in the storage unit 170. Here, “forcible storage” may be done using a special storage method that differs from a normal storage method used for the “normal storage”. For example, “normal storage” may involve storing the banknote P as-is, while “forcible storage” may involve storing the banknote P in an envelope. The first stacking unit 160 serves as one example of the claimed discharge port.

The banknotes P that are not conveyed to the first stacking unit 160 may be conveyed to and stacked in the second stacking unit 165. In this exemplary embodiment, in the first-stage processing, the second stacking unit 165 may stack the banknotes P discriminated as the second banknote by the discrimination sensor 140. In the second-stage processing, the second stacking unit 165 may stack the banknote P discriminated as the damaged banknote by the discrimination sensor 140.

Also, as shown in FIG. 2, the safe box housing 114 may be provided with the storage unit 170. The storage unit 170 may receive and store the banknotes P stacked in the first stacking unit 160. The storage unit 170 may be provided with a slit opening 171 for taking in the banknotes P transported by the clamping and transporting mechanism 169. The storage unit 170 may be provided with a slit shutter 172 to open and close the slit opening 171. In this exemplary embodiment, the storage unit 170 may store as-is the banknotes P stacked in the first stacking unit 160 in the first-stage processing. The storage unit 170 may store the banknotes P stacked in the first stacking unit 160 in the second-stage processing, with the banknotes P enclosed. The storage unit 170 serves as one example of the claimed one storage of at least one storage.

Furthermore, as shown in FIG. 2, the banknote processing device 1 may include a control unit 190. The control unit 190 may be a central processing unit (CPU) and may be connected to a random access memory (RAM), a read-only memory (ROM), a hard disk drive (HDD), etc., which are not shown. The control unit 190 may control the entire banknote processing device 1, for example, by reading a program stored in the ROM into the RAM and executing the program.

In this exemplary embodiment, the control unit 190 may use the printer 106 to print forcible storage information on paper or envelopes when the banknotes P discriminated as the suspicious banknotes by the discrimination sensor 140 are stacked in the first stacking unit 160 in the second-stage processing. Here, the forcible storage information may be information based on the result of the discrimination of the banknote P by the discrimination sensor 140. In other words, the forcible storage information may be information that can be obtained without user intervention. Such information may include, for example, information identifying a transaction related to the banknote P, information identifying a user performing the transaction, the number of sheets of the banknote P, a currency type of the banknote P, a denomination of the banknote P, a symbolic code number of the banknote P, and information indicating that the forcible storage is performed in the transaction. The symbolic code number is a unique code corresponding to a unique combination of one or more numbers and/or one or more letters, which is also called a serial number. If the forcible storage information is printed on the paper, the paper and the banknote P discriminated as the suspicious banknote may be put in an envelope by the user and the envelope may be stored in the storage unit 170. If the forcible storage information is printed on the envelope, the banknote P discriminated as the suspicious banknote may be put in the envelope by the user and the envelope may be stored in the storage unit 170.

The control unit 190 may print the forcible storage information using the printer 106 on paper or envelopes in response to banknotes P discriminated as the true banknotes being stored in the storage unit 170 in the first-stage processing and one or more banknotes P discriminated as the suspicious banknotes being stacked in the first stacking unit 160 in the second-stage processing. The control unit 190 serves as one example of the claimed controller for performing output processing to output forcible storage information used in forcible storage of the second banknote, the forcible storage information being output without user intervention. The control unit 190 also serves as one example of the claimed controller for performing the output processing in response to the first banknote being stored in the one storage and the second banknote being discharged to the discharge port.

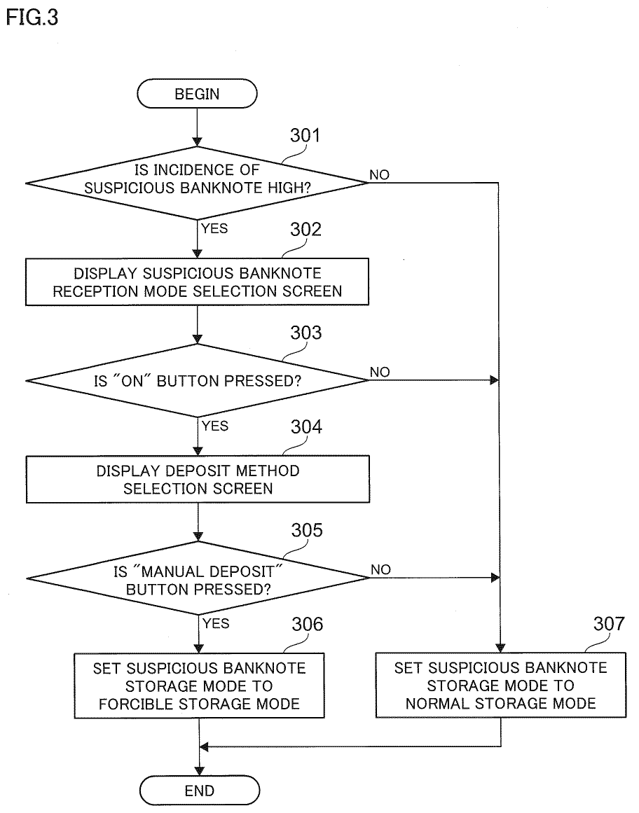

FIG. 3 is a flowchart showing an example of a setting operation of the banknote processing device 1 in the first exemplary embodiment. This example setting operation is an example of an operation when the banknote processing device 1 sets a suspicious banknote storage mode. Although strictly speaking this example setting operation is executed by the control unit 190 of the banknote processing device 1, it is described below as being executed by the banknote processing device 1.

As shown in FIG. 3, the banknote processing device 1 may first determine whether an incidence of the suspicious banknote is high (step 301). Here, the incidence of the suspicious banknote may be the number of banknotes each discriminated as the suspicious banknote during a predetermined period of time. The predetermined period may be, for example, 10 days. The banknote processing device 1 may determine whether the incidence of the suspicious banknote is high, for example, by checking whether the incidence of the suspicious banknote is above a predetermined threshold value.

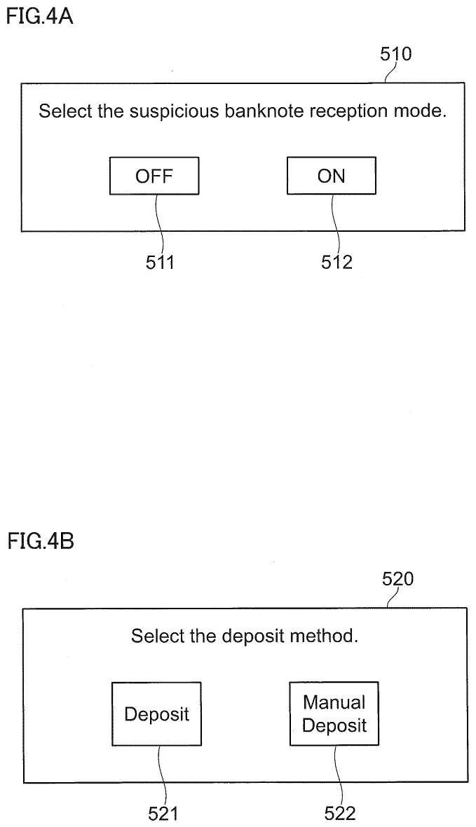

If the incidence of the suspicious banknote is not determined to be high at step 301, that is, if the incidence of the suspicious banknote is determined to be low, the banknote processing device 1 may set the suspicious banknote storage mode to a normal storage mode (step 307), and may terminate the process. On the other hand, if the incidence of the suspicious banknote is determined to be high at step 301, the banknote processing device 1 may display a suspicious banknote reception mode selection screen (step 302). FIG. 4A shows a screen 510, which is an example of the suspicious banknote reception mode selection screen. As shown in FIG. 4A, the screen 510 may include an “OFF” button 511 and an “ON” button 512. The screen 510 may include, instead of the “ON” button 512, plural buttons each corresponding to one of plural occurrence factors of the suspicious banknote, but in relation to FIG. 4A, the “ON” button 512 will be described. With the suspicious banknote reception mode selection screen displayed, the banknote processing device 1 may determine whether the “ON” button 512 is pressed (step 303).

If the “ON” button 512 is not determined to be pressed at step 303, that is, if the “OFF” button 511 is determined to be pressed, the banknote processing device 1 may set the suspicious banknote storage mode to the normal storage mode (step 307), and may terminate the process. On the other hand, if the “ON” button 512 is determined to be pressed at step 303, the banknote processing device 1 may display a deposit method selection screen (step 304). FIG. 4B shows a screen 520, which is an example of the deposit method selection screen. As shown in FIG. 4B, the screen 520 may include a “deposit” button 521 and a “manual deposit” button 522. With the deposit method selection screen displayed, the banknote processing device 1 may determine whether “manual deposit” button 522 is pressed (step 305).

If the “manual deposit” button 522 is not determined to be pressed at step 305, that is, if the “deposit” button 521 is determined to be pressed, the banknote processing device 1 may set the suspicious banknote storage mode to the normal storage mode (step 307), and may terminate the process. On the other hand, if the “manual deposit” button 522 is determined to be pressed at step 305, the banknote processing device 1 may set the suspicious banknote storage mode to a forcible storage mode (step 306), and may terminate the process.

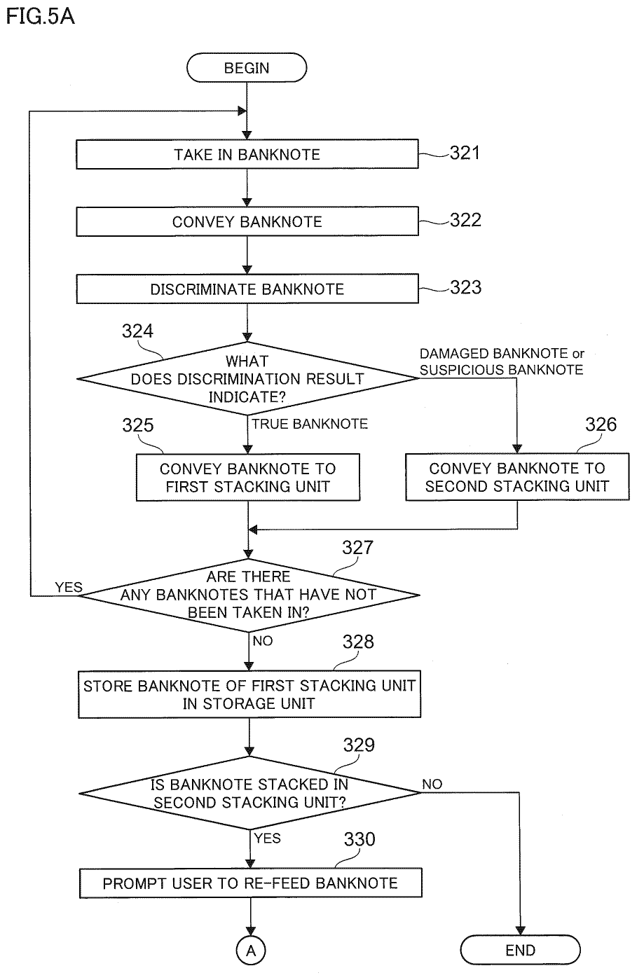

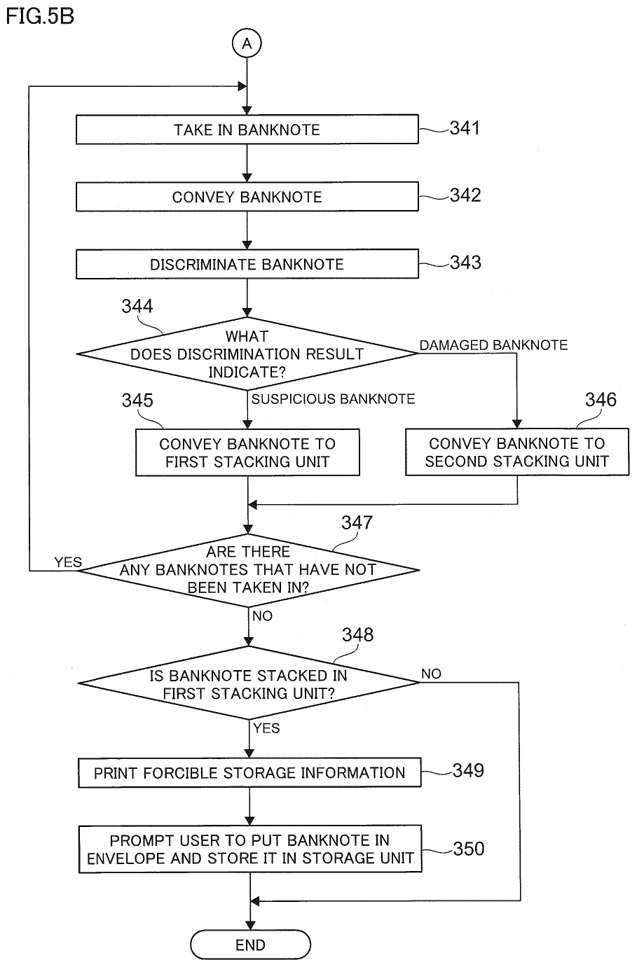

FIGS. 5A and 5B are flowcharts showing an example of a storing operation of the banknote processing device 1 in the first exemplary embodiment. This example storing operation is an example of an operation when the banknote processing device 1 stores banknotes in the storage unit in a state where the suspicious banknote storage mode is set to the forcible storage mode in the example setting operation of FIG. 3. FIG. 5A shows an example of the operation in the first-stage processing, and FIG. 5B shows an example of the operation in the second-stage processing. In this example storing operation, it is assumed that the first banknote is the true banknote and the second banknote is the suspicious banknote excluding the damaged banknote. Unless explicitly stated otherwise, this example storing operation may be performed based on signals sent from the control unit 190 to each part.

As shown in FIG. 5A, in the first-stage processing, in the banknote processing device 1, the intake unit 125 may take in one banknote from plural banknotes placed on the deposit unit 120 (step 321). Then, the conveyance unit 130 may convey the banknote taken in at step 321 (step 322). The discrimination sensor 140 may then discriminate the banknote conveyed at step 322 (step 323). The control unit 190 may then determine which of the true banknote, the damaged banknote, or the suspicious banknote the discrimination result at step 323 indicates (step 324).

If the discrimination result at step 323 is determined to indicate the true banknote, the conveyance unit 130 may convey the banknote to the first stacking unit 160 (step 325). On the other hand, if the discrimination result at step 323 is determined to indicate the damaged banknote or the suspicious banknote, the conveyance unit 130 may convey the banknote to the second stacking unit 165 (step 326).

After that, the control unit 190 may determine whether there are any banknotes that have been placed on the deposit unit 120 but have not been taken in (step 327). If it is determined at step 327 that there are one or more banknotes that have been placed but not taken in, the control unit 190 may return the process to step 321. On the other hand, if it is determined at step 327 that there are no banknotes that have been placed but not yet taken in, that is, if it is determined that all placed banknotes have been taken in, the clamping and transporting mechanism 169 may store in the storage unit 170 banknotes discriminated as the true banknotes and stacked in the first stacking unit 160 (step 328). The control unit 190 may then determine whether one or more banknotes are stacked in the second stacking unit 165 (step 329).

If it is not determined at step 329 that one or more banknotes are stacked in the second stacking unit 165, the control unit 190 may terminate the process. On the other hand, if it is determined at step 329 that one or more banknotes are stacked in the second stacking unit 165, the control unit 190 may prompt a user to re-feed from the deposit unit 120 the one or more banknotes stacked in the second stacking unit 165 (step 330). For example, the control unit 190 may display a message on the display input unit 105 prompting the user to re-place the one or more banknotes on the deposit unit 120. The control unit 190 may then proceed to FIG. 5B.

As shown in FIG. 5B, in the second-stage processing, in the banknote processing device 1, the intake unit 125 may take in one banknote from plural banknotes placed on the deposit unit 120 (step 341). Then, the conveyance unit 130 may convey the banknote taken in at step 341 (step 342). The discrimination sensor 140 may then discriminate the banknote conveyed at step 342 (step 343). The control unit 190 may then determine which of the damaged banknote or the suspicious banknote the discrimination result at step 343 indicates (step 344). In some cases, a banknote discriminated as the damaged banknote or the suspicious banknote in the first-stage processing may be discriminated as the true banknote in the second-stage processing, and thus the control unit 190 may determine at step 344 which of the true banknote, the damaged banknote, or the suspicious banknote the discrimination result at step 343 indicates. However, such cases shall not be considered here.

If the discrimination result at step 343 is determined to indicate the suspicious banknote, the conveyance unit 130 may convey the banknote to the first stacking unit 160 (step 345). On the other hand, if the discrimination result at step 343 is determined to indicate the damaged banknote, the conveyance unit 130 may convey the banknote to the second stacking unit 165 (step 346).

After that, the control unit 190 may determine whether there are any banknotes that have been placed on the deposit unit 120 but have not been taken in (step 347). If it is determined at step 347 that there are one or more banknotes that have been placed but not taken in, the control unit 190 may return the process to step 341. On the other hand, if it is determined at step 347 that there are no banknotes that have been placed but not yet taken in, that is, if it is determined that all placed banknotes have been taken in, the control unit 190 may determine whether one or more banknotes are stacked in the first stacking unit 160 (step 348).

If it is not determined at step 348 that one or more banknote are stacked in the first stacking unit 160, the control unit 190 may terminate the process. On the other hand, if it is determined at step 348 that one or more banknotes are stacked in the first stacking unit 160, the control unit 190 may print the forcible storage information based on the discrimination result at step 343 on paper or an envelope (step 349). For example, the control unit 190 may print the forcible storage information using printer 106. Also, the control unit 190 may prompt a user to put the one or more banknotes stacked in the first stacking unit 160 in the envelope and store the envelope in the storage unit 170 (step 350), and may terminate the process. For example, if the forcible storage information is printed on the paper, the control unit 190 may display a message on the display input unit 105 prompting the user to put the paper and the one or more banknotes stacked in the first stacking unit 160 in the envelope and store the envelope in the storage unit 170. If the forcible storage information is printed on the envelope, the control unit 190 may display a message on the display input unit 105 prompting the user to put the one or more banknotes stacked in the first stacking unit 160 in the envelope and store the envelope in the storage unit 170. In such a case, the control unit 190 may use light emitting diodes (LEDs) or other means to inform the user of the location of the storage unit 170 where the envelope is to be stored. This causes the user to store the suspicious banknote in the envelope in the storage unit 170 with the forcible storage information clearly indicated without any user action. The damaged banknotes conveyed to the second stacking unit 165 at step 346 may be stored in the storage unit 170. Information about the true banknotes, information about the damaged banknotes, and information about the suspicious banknotes obtained by the process described in FIGS. 5A and 5B are linked as related to the same transaction and stored in the memory (not shown).

In the above, banknotes discriminated as the suspicious banknotes are put in an envelope and stored in the storage unit 170, but banknotes discriminated as the damaged banknotes or the suspicious banknotes may be put in an envelope and stored in the storage unit 170. This can result in the envelope containing no suspicious banknotes. For such cases, envelopes containing any suspicious banknotes may be made different from those containing no suspicious banknotes. Methods for differentiating envelopes may include a method of using visually different envelopes, a method of attaching codes to the envelopes to distinguish them, and the like.

### Second Exemplary Embodiment

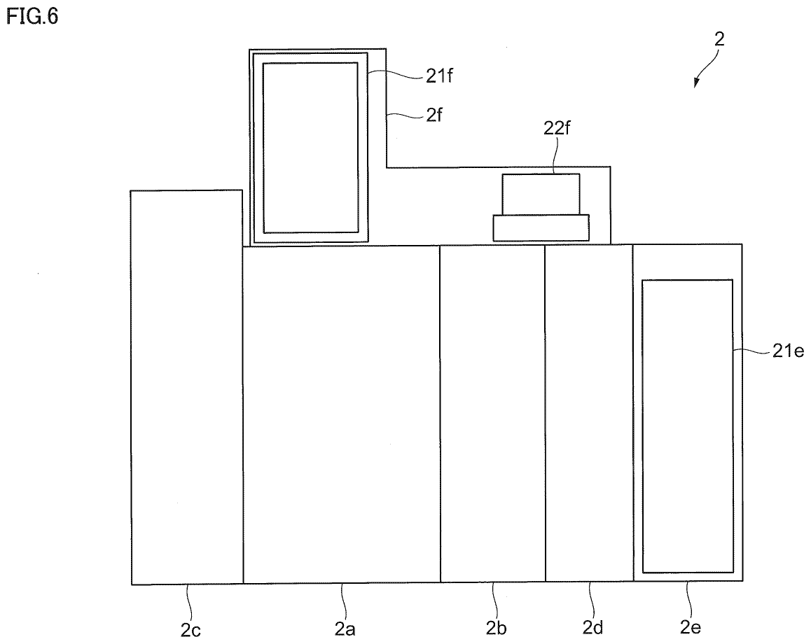

FIG. 6 is a front view of an example configuration of a currency processing system 2 in the second exemplary embodiment. As shown in FIG. 6, the currency processing system 2 may include a banknote processing device 2a, a loose coin processing device 2b, a coin roll processing device 2c, a check processing device 2d, a drop box 2e, and a peripheral device 2f.

The banknote processing device 2a may be a device that processes banknotes. The banknote processing device 2a serves as one example of the claimed apparatus for processing banknote. The banknote processing device 2a also serves as one example of the claimed first apparatus. The banknote processing device 2a is described in detail below. The loose coin processing device 2b may be a device that processes loose coins. The coin roll processing device 2c may be a device that processes coin rolls (coin bars). The check processing device 2d may be a device that processes checks.

The drop box 2e may be a device that stores banknotes that cannot be accepted by the banknote processing device 2a. Specifically, the drop box 2e may include a storage unit 21e, and the storage unit 21e may store such banknotes. In FIG. 6, the drop box 2e is arranged separate from the banknote processing device 2a, but this arrangement is not limiting. The drop box 2e may be contained within the banknote processing device 2a, or may be arranged adjacent to the banknote processing device 2a. The drop box 2e serves as one example of the claimed second apparatus, and the storage unit 21e serves as one example of the claimed second storage of at least one storage.

The peripheral device 2f may include a display input unit 21f and a printer 22f. The display input unit 21f may have a function to display predetermined information and a function to enable data input. The printer 22f may have a function to print predetermined information.

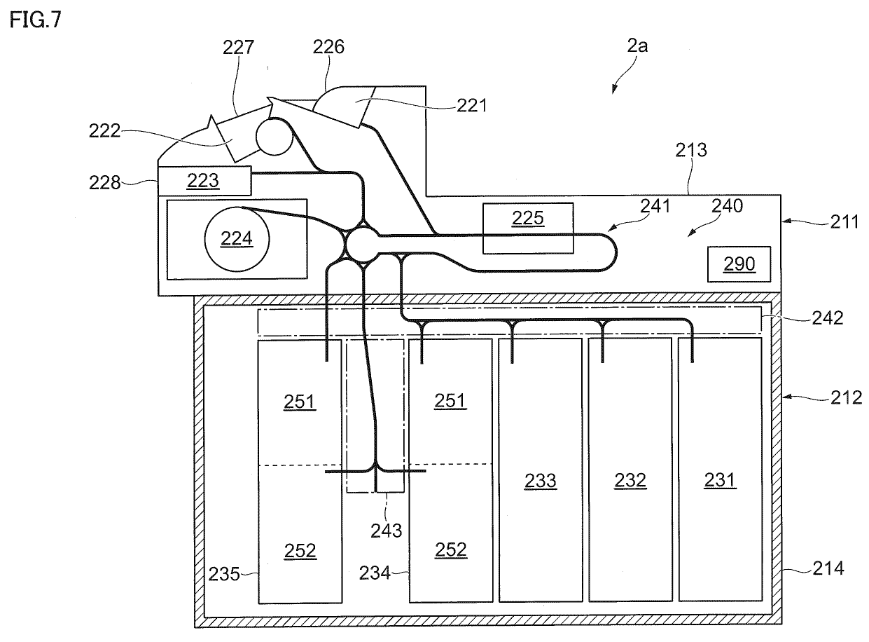

FIG. 7 is a side view of an example configuration of the banknote processing device 2a in the second exemplary embodiment. As shown in FIG. 7, the banknote processing device 2a may include an upper processing part 211 and a lower safe box part 212.

The processing part 211 may be composed of an upper housing 213. The upper housing 213 may be provided with a deposit unit 221, a discharge unit 222, a stacking unit 223, a temporary storage unit 224, a discrimination sensor 225, and an upper conveyance unit 241. The upper conveyance unit 241 is a part of the conveyance unit 240. The stacking unit 223 may be optional. In other words, the stacking unit 223 may not be provided. Alternatively, the stacking unit 223 may or may not be used in a configuration where the stacking unit 223 is provided.

The deposit unit 221 may receive one or more banknotes to be deposited, for example, during deposit processing. The deposit unit 221 may include a deposit opening 226. The user may manually deposit the one or more banknotes into the deposit unit 221 through the deposit opening 226. The deposit unit 221 can hold plural banknotes in a stacked state. The deposit unit 221 may have a mechanism to take the plural banknotes one by one into the banknote processing device 2a. The deposit unit 221 serves as one example of the claimed intake port.

The discharge unit 222 may stack one or more banknotes drawn out from a storage unit, for example, during withdrawal processing. The discharge unit 222 can hold plural banknotes in a stacked state. The discharge unit 222 may include a discharge opening 227. The user can manually take out the plural banknotes stacked in the discharge unit 222 through the discharge opening 227.

The discharge unit 222 may also stack one or more banknotes that are not stored in the storage unit, for example, during deposit processing. Specifically, in a configuration where the stacking unit 223 is provided, the discharge unit 222 may stack one or more banknotes discriminated as the damaged banknotes by the discrimination sensor 225. In this case, the discharge unit 222 serves as one example of the claimed first discharge port. The banknote discriminated as the damaged banknote is used as one example of the claimed second banknote as the first category. In a configuration where the stacking unit 223 is not provided or where the stacking unit 223 is provided but not used, one or more banknotes discriminated as the damaged banknotes by the discrimination sensor 225 may be conveyed to the discharge unit 222, and then, in response to the user removing the one or more banknotes from the discharge unit 222, one or more banknotes discriminated as the suspicious banknotes by the discrimination sensor 225 may be conveyed to the discharge unit 222. The one or more banknotes discriminated as the suspicious banknotes may be forcibly stored in the storage unit 21e of the drop box 2e. Here, “forcible storage” may be done using a special storage method that differs from a normal storage method used for the “normal storage”. For example, “normal storage” may involve storing the banknote as-is, while “forcible storage” may involve storing the banknote in an envelope. In this case, the discharge unit 222 serves as one example of the claimed discharge port. The banknote discriminated as the damaged banknote is used as one example of the claimed second banknote as the first category, and the banknote discriminated as the suspicious banknote is used as one example of the claimed second banknote as the second category. Alternatively, in such a configuration, one or more banknotes discriminated as the suspicious banknotes by the discrimination sensor 225 may be conveyed to the discharge unit 222, and then, in response to the user removing the one or more banknotes from the discharge unit 222, one or more banknote discriminated as the damaged banknotes by the discrimination sensor 225 may be conveyed to the discharge unit 222. The one or more banknotes discriminated as the suspicious banknotes may be forcibly stored in the storage unit 21e of the drop box 2e. Here, “forcible storage” may be done using a special storage method that differs from a normal storage method used for the “normal storage”. For example, “normal storage” may involve storing the banknote as-is, while “forcible storage” may involve storing the banknote in an envelope. In this case, the discharge unit 222 serves as one example of the claimed discharge port. The banknote discriminated as the suspicious banknote is used as one example of the claimed second banknote as the first category, and the banknote discriminated as the damaged banknote is used as one example of the claimed second banknote as the second category.

The stacking unit 223 may stack one or more banknotes that are not stored in the storage unit, for example, during deposit processing. Specifically, one or more banknotes discriminated as the suspicious banknotes by the discrimination sensor 225 may be conveyed to the stacking unit 223. The stacking unit 223 may be configured to hold plural banknotes in a stacked state. The stacking unit 223 may include a discharge opening 228. Although not shown, the discharge opening 228 may be provided with a shutter. When the shutter is opened, the user can take out the banknotes stacked in the stacking unit 223 through the discharge opening 228. The one or more banknotes discriminated as the suspicious banknotes may be forcibly stored in the storage unit 21e of the drop box 2e. Here, “forcible storage” may be done using a special storage method that differs from a normal storage method used for the “normal storage”. For example, “normal storage” may involve storing the banknote as-is, while “forcible storage” may involve storing the banknote in an envelope. In this case, the stacking unit 223 serves as one example of the claimed discharge port or the claimed second discharge port. The banknote discriminated as the suspicious banknote is used as one example of the claimed second banknote as the second category.

The temporary storage unit 224 may temporarily store one or more banknotes that are to be stored in a storage unit, for example, during deposit processing. The temporary storage unit 224 can eject the stored banknotes. The temporary storage unit 224 may be a tape-type storage unit. The temporary storage unit 224 may store the banknotes by wrapping the banknotes around a drum with a tape. The tape-type storage unit has an advantage in that the order of the banknotes is not changed when storing and unloading the banknotes. The tape-type storage unit also has an advantage of being able to store the banknotes of various sizes in a mixed state. The temporary storage unit 224 can adopt any well-known configuration of tape-type storage units.

The temporary storage unit 224 may also temporarily store one or more banknotes that are not to be stored in the storage unit but are to be conveyed to the discharge unit 222, for example, during deposit processing. Specifically, in a configuration where the stacking unit 223 is not provided or where the stacking unit 223 is provided but not used, when one or more banknotes discriminated as the damaged banknotes are conveyed to the discharge unit 222 and then one or more banknotes discriminated as the suspicious banknotes are conveyed to the discharge unit 222, the temporary storage unit 224 may store the one or more banknotes discriminated as the suspicious banknote. Alternatively, in such a configuration, when one or more banknotes discriminated as the suspicious banknotes are conveyed to the discharge unit 222 and then one or more banknotes discriminated as the damaged banknotes are conveyed to the discharge unit 222, the temporary storage unit 224 may store the one or more banknotes discriminated as the damaged banknotes.

The discrimination sensor 225 may be provided on the upper conveyance unit 241. The discrimination sensor 225 may discriminate at least one of the currency, authenticity, denomination, and normal/damaged state for each banknote conveyed along the upper conveyance unit 241. The discrimination sensor 225 may also read a symbolic code number printed on each banknote. In this exemplary embodiment, the discrimination sensor 225 may discriminate whether the banknote conveyed by the upper conveyance unit 241 is the first banknote or the second banknote. The first banknote may be the true banknote. The second banknote may be the suspicious banknote excluding the damaged banknote, or both the damaged banknote and the suspicious banknote. In addition, the discrimination sensor 225 may discriminate whether the banknote conveyed by the upper conveyance unit 241 is the damaged banknote or the suspicious banknote when discriminating the banknote as the second banknote.

The safe box part 212 may be composed of a safe box housing 214. The safe box housing 214 may be provided with plural storage units 231 to 235 and lower conveyance units 242 and 243. The lower conveyance units 242 and 243 are parts of the conveyance unit 240. The safe box housing 214 may protect the plural storage units 231 to 235 with a predetermined or higher level of security. Specifically, the safe box housing 214 may be formed by a metal plate of a predetermined thickness or greater. The security level of the safe box housing 214 may be higher than that of the upper housing 213.

The first storage unit 231, the second storage unit 232, and the third storage unit 233 may have the same configuration. The storage unit 233, the second storage unit 232, and the third storage unit 233 may each be a stack type storage unit, although detailed illustrations are omitted. The stack type storage unit stores banknotes in a stacked state. The first storage unit 231, the second storage unit 232, and the third storage unit 233 may each contain one storage area. The first storage unit 231, the second storage unit 232, and the third storage unit 233 may each store banknotes in the storage area and may each eject banknotes from the storage area. The first storage unit 231, the second storage unit 232, and the third storage unit 233 may each be configured to eject banknotes such that the banknote stored first is ejected last.

The fourth storage unit 234 and the fifth storage unit 235 may have the same configuration. The fourth storage unit 234 and the fifth storage unit 235 may each be a stack type storage unit. The fourth storage unit 234 and the fifth storage unit 235 may each include a first storage space 251 and a second storage space 252. The first storage space 251 may be provided on the top side. The second storage space 252 may be provided below the first storage space 251. The first storage space 251 and the second storage space 252 may be independent of each other. The fourth storage unit 234 and the fifth storage unit 235 may each have a first conveyance mechanism for the first storage space 251 and a second conveyance mechanism for the second storage space 252. The fourth storage unit 234 and the fifth storage unit 235 can also store banknotes in the first storage space 251 and eject the banknotes from the first storage space 251, and can store banknotes in the second storage space 252 and eject the banknotes from the second storage space 252. The fourth storage unit 234 and the fifth storage unit 235 may each also be configured to eject banknotes such that the banknote stored first is ejected last.

The configuration of the storage units in FIG. 7 is an example, and the number and arrangement of the storage units in the safe box housing 214 and the structure of each storage unit are not limited to the configuration in FIG. 7. Each of the plural storage units 231 to 235 serves as one example of the claimed first storage of at least one storage unit.

The conveyance unit 240 may convey banknotes one by one at intervals therebetween within the banknote processing device 2a. The conveyance unit 240 may include conveyance paths. The conveyance paths may be composed of a combination of a number of rollers, a number of belts, a motor driving them, and a number of guides, which are not shown. The conveyance unit 240 may convey banknotes with the edges of the short sides of the banknotes facing forward.

The conveyance unit 240 may include the upper conveyance unit 241 and the lower conveyance units 242 and 243. The upper conveyance unit 241 may be provided in the upper housing 213 as described above. The lower conveyance units 242 and 243 may be provided in the safe box housing 214 as described above. Three conveyance paths may be formed through the upper wall of the safe box housing 214 in the vertical direction. The three conveyance paths may connect the upper conveyance unit 241 with the lower conveyance units 242 and 243. The conveyance unit 240 serves as one example of the claimed conveyor for conveying the banknote taken in from the intake port.

Further, as shown in FIG. 7, the banknote processing device 2a may include a control unit 290. The control unit 290 may be a CPU and may be connected to a RAM, a ROM, and an HDD, etc., which are not shown. The control unit 290 may control the entire currency processing system 2, for example, by reading a program stored in the ROM into the RAM and executing the program.

In this exemplary embodiment, in a configuration where the stacking unit 223 is provided and used, the control unit 290 may use the printer 22f to print forcible storage information on paper or envelopes in response to the banknotes discriminated as the suspicious banknotes by the discrimination sensor 225 being stacked in the stacking unit 223. In a configuration where the stacking unit 223 is not provided or is provided but not used, the control unit 290 may use the printer 22f to print forcible storage information on paper or envelopes in response to the banknotes discriminated as the suspicious banknotes by the discrimination sensor 225 being stacked in the discharge unit 222. Here, the forcible storage information may be information based on the result of the discrimination of the banknote by the discrimination sensor 225. In other words, the forcible storage information may be information that can be obtained without user intervention. Such information may include, for example, information identifying a transaction related to the banknote, information identifying a user performing the transaction, the number of sheets of the banknote, a currency type of the banknote, a denomination of the banknote, a symbolic code number of the banknote, and information indicating that the forcible storage is performed in the transaction. If the forcible storage information is printed on the paper, the paper and the banknote discriminated as the suspicious banknote may be put in an envelope by the user and the envelope may be stored in the storage unit 21e (see FIG. 6). If the forcible storage information is printed on the envelope, the banknote discriminated as the suspicious banknote may be put in the envelope by the user and the envelope may be stored in the storage unit 21e (see FIG. 6).

The control unit 290 may, in a configuration where the stacking unit 223 is provided and used, print the forcible storage information using the printer 22f on paper or envelopes in response to banknotes discriminated as the true banknotes being stored in any of the plural storage units 231 to 235 and one or more banknotes discriminated as the suspicious banknotes being stacked in the stacking unit 223. The control unit 290 may, in a configuration where the stacking unit 223 is not provided or where the stacking unit 223 is provided but not used, print the forcible storage information using the printer 22f on paper or envelopes in response to banknotes discriminated as the true banknote being stored in any of the plural storage units 231 to 235 and one or more banknotes discriminated as the suspicious banknotes being stacked in the discharge unit 222. The control unit 290 serves as one example of the claimed controller for performing output processing to output forcible storage information used in forcible storage of the second banknote, the forcible storage information being output without user intervention. The control unit 290 also serves as one example of the claimed controller for performing the output processing in response to the first banknote being stored in the one storage and the second banknote being discharged to the discharge port.

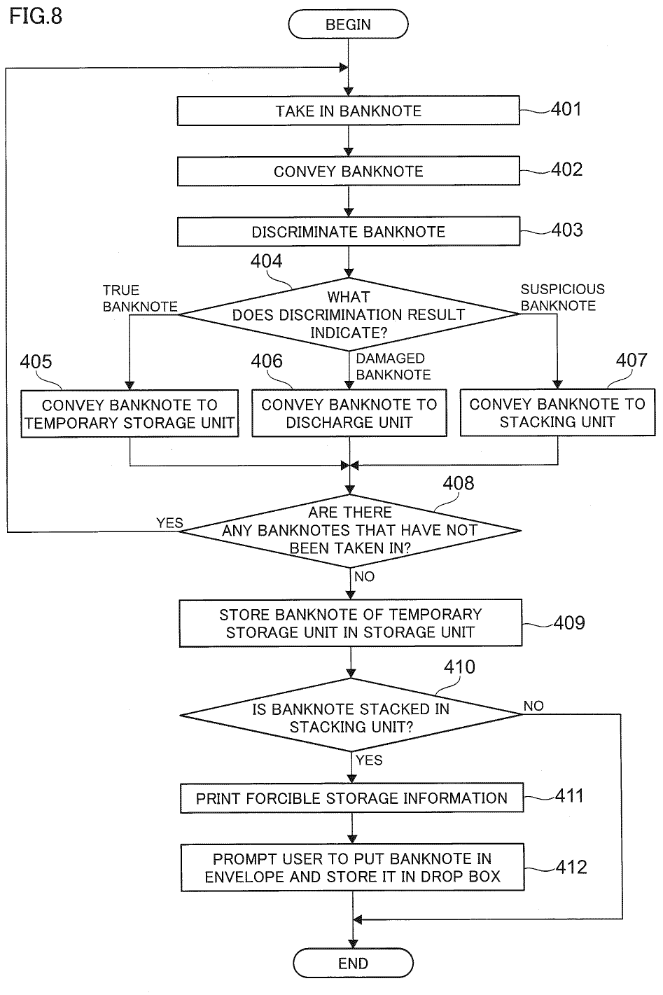

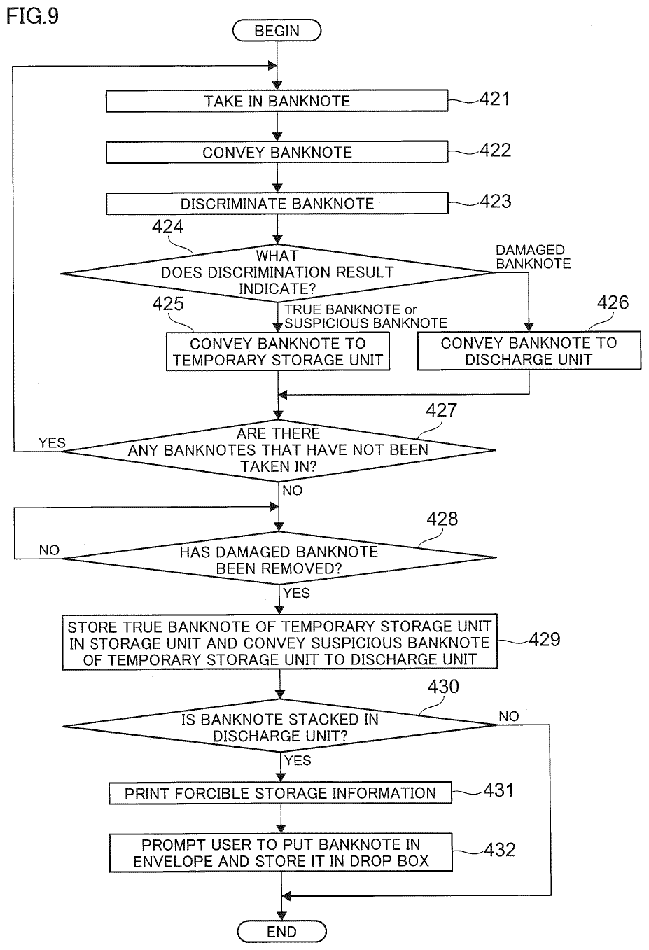

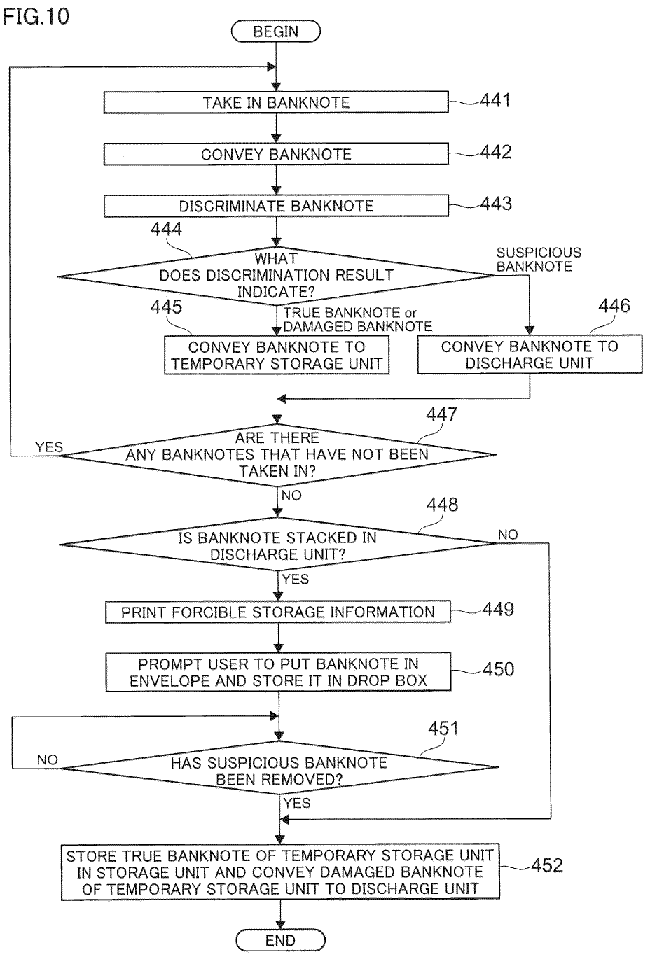

FIGS. 8 to 10 are flowcharts showing examples of storing operations of the banknote processing device 2a in the second exemplary embodiment. These example storing operations are examples of operations when the banknote processing device 2a stores banknotes in the storage unit. FIG. 8 shows an example of an operation in a configuration where the stacking unit 223 is provided and used. FIGS. 9 and 10 show examples of the first and second operations in a configuration where the stacking unit 223 is not provided or is provided but not used, respectively. In these example storing operations, it is assumed that the first banknote is the true banknote and the second banknote is the suspicious banknote excluding the damaged banknote. Unless explicitly stated otherwise, these example storing operations may be performed based on signals sent from the control unit 290 to each part.

As shown in FIG. 8, in the example of the operation in the configuration where the stacking unit 223 is provided and used, in the banknote processing device 2a, the deposit unit 221 may take in one banknote from plural banknotes placed on the deposit unit 221 (step 401). Then, the conveyance unit 240 may convey the banknote taken in at step 401 (step 402). The discrimination sensor 225 may then discriminate the banknote conveyed at step 402 (step 403). The control unit 290 may then determine which of the true banknote, the damaged banknote, or the suspicious banknote the discrimination result at step 403 indicates (step 404).

If the discrimination result at step 403 is determined to indicate the true banknote, the conveyance unit 240 may convey the banknote to the temporary storage unit 224 (step 405). Also, if the discrimination result at step 403 is determined to indicate the damaged banknote, the conveyance unit 240 may convey the banknote to the discharge unit 222 (step 406). Further, if the discrimination result at step 403 is determined to indicate the suspicious banknote, the conveyance unit 240 may convey the banknote to the stacking unit 223 (step 407).

After that, the control unit 290 may determine whether there are any banknotes that have been placed on the deposit unit 221 but have not been taken in (step 408). If it is determined at step 408 that there are one or more banknotes that have been placed but not taken in, the control unit 290 may return the process to step 401. On the other hand, if it is determined at step 408 that there are no banknotes that have been placed but not yet taken in, that is, if it is determined that all placed banknotes have been taken in, the conveyance unit 240 may store banknotes discriminated as the true banknotes in any of the plural storage units 231 to 235 (step 409). The control unit 290 may then determine whether one or more banknotes are stacked in the stacking unit 223 (step 410).

If it is not determined at step 410 that one or more banknotes are stacked in the stacking unit 223, the control unit 290 may terminate the process. On the other hand, if it is determined at step 410 that one or more banknotes are stacked in the stacking unit 223, the control unit 290 may print the forcible storage information based on the discrimination result at step 403 on paper or an envelope (step 411). For example, the control unit 290 may print the forcible storage information using the printer 22f. Also, the control unit 290 may prompt a user to put the one or more banknotes stacked in the stacking unit 223 in the envelope and store the envelope in the storage unit 21e of the drop box 2e (step 412), and terminate the process. For example, if the forcible storage information is printed on the paper, the control unit 290 may display a message on the display input unit 21f prompting the user to put the paper and the one or more banknotes stacked in the stacking unit 223 in the envelope and store the envelope in the storage unit 21e. If the forcible storage information is printed on the envelope, the control unit 290 may display a message on the display input unit 21f prompting the user to put the one or more banknotes stacked in the stacking unit 223 in the envelope and store the envelope in the storage unit 21e. In such a case, the control unit 290 may use LEDs or other means to inform the user of the location of the storage unit 21e of the drop box 2e where the envelope is to be stored. This causes the user to store the suspicious banknote in the envelope in the storage unit 21e of the drop box 2e with the forcible storage information clearly indicated without any user action. The damaged banknotes conveyed to the discharge unit 222 at step 406 may be stored in the storage unit 21e of the drop box 2e. Information about the true banknotes, information about the damaged banknotes, and information about the suspicious banknotes obtained by the process described in FIG. 8 are linked as related to the same transaction and stored in the memory (not shown).

As shown in FIG. 9, in the first operation example in the configuration where the stacking unit 223 is not provided or is provided but not used, in the banknote processing device 2a, the deposit unit 221 may take in one banknote from plural banknotes placed on the deposit unit 221 (step 421). Then, the conveyance unit 240 may convey the banknote taken in at step 421 (step 422). The discrimination sensor 225 may then discriminate the banknote conveyed at step 422 (step 423). The control unit 290 may then determine which of the true banknote, the damaged banknote, or the suspicious banknote the discrimination result at step 423 indicates (step 424).

If the discrimination result at step 423 is determined to indicate the true banknote or the suspicious banknote, the conveyance unit 240 may convey the banknote to the temporary storage unit 224 (step 425). On the other hand, if the discrimination result at step 423 is determined to indicate the damaged banknote, the conveyance unit 240 may convey the banknote to the discharge unit 222 (step 426).

After that, the control unit 290 may determine whether there are any banknotes that have been placed on the deposit unit 221 but have not been taken in (step 427). If it is determined at step 427 that there are one or more banknotes that have been placed but not taken in, the control unit 290 may return the process to step 421. On the other hand, if it is determined at step 427 that there are no banknotes that have been placed but not yet taken in, that is, if it is determined that all placed banknotes have been taken in, the control unit 290 may determine whether all damaged banknotes stacked in the discharge unit 222 have been removed by the user (step 428). If it is not determined at step 428 that all damaged banknotes have been removed, the control unit 290 repeats step 428. On the other hand, if it is determined at step 428 that all damaged banknotes have been removed, the conveyance unit 240 may store banknotes discriminated as the true banknotes in any of the plural storage units 231 to 235, and may convey one or more banknotes discriminated as the suspicious banknotes to the discharge unit 222, among banknotes stored in the temporary storage unit 224 (step 429). Here, it may be determined whether each banknote stored in the temporary storage unit 224 is the true banknote or the suspicious banknote based on the symbolic code number read from each banknote by the discrimination sensor 225. The control unit 290 may then determine whether one or more banknotes are stacked in the discharge unit 222 (step 430).

If it is not determined at step 430 that one or more banknotes are stacked in the discharge unit 222, the control unit 290 may terminate the process. On the other hand, if it is determined at step 430 that one or more banknotes are stacked in the discharge unit 222, the control unit 290 may print the forcible storage information based on the discrimination result at step 423 on paper or an envelope (step 431). For example, the control unit 290 may print the forcible storage information using the printer 22f. Also, the control unit 290 may prompt a user to put the one or more banknotes stacked in the discharge unit 222 in the envelope and store the envelope in the storage unit 21e of the drop box 2e (step 432), and terminate the process. For example, if the forcible storage information is printed on the paper, the control unit 290 may display a message on the display input unit 21f prompting the user to put the paper and the one or more banknotes stacked in the discharge unit 222 in the envelope and store the envelope in the storage unit 21e. If the forcible storage information is printed on the envelope, the control unit 290 may display a message on the display input unit 21f prompting the user to put the one or more banknotes stacked in the discharge unit 222 in the envelope and store the envelope in the storage unit 21e. In such a case, the control unit 290 may use LEDs or other means to inform the user of the location of the storage unit 21e of the drop box 2e where the envelope is to be stored. This causes the user to store the suspicious banknote in the envelope in the storage unit 21e of the drop box 2e with the forcible storage information clearly indicated without any user action. The damaged banknotes conveyed to the discharge unit 222 at step 426 may be stored in the storage unit 21e of the drop box 2e. Information about the true banknotes, information about the damaged banknotes, and information about the suspicious banknotes obtained by the process described in FIG. 9 are linked as related to the same transaction and stored in the memory (not shown).

As shown in FIG. 10, in the second operation example in the configuration where the stacking unit 223 is not provided or is provided but not used, in the banknote processing device 2a, the deposit unit 221 may take in one banknote from plural banknotes placed on the deposition unit 221 (step 441). Then, the conveyance unit 240 may convey the banknote taken in at step 441 (step 442). The discrimination sensor 225 may then discriminate the banknote conveyed at step 442 (step 443). The control unit 290 may then determine which of the true banknote, the damaged banknote, or the suspicious banknote the discrimination result at step 443 indicates (step 444).

If the discrimination result at step 443 is determined to indicate the true banknote or the damaged banknote, the conveyance unit 240 may convey the banknote to the temporary storage unit 224 (step 445). On the other hand, if the discrimination result at step 443 is determined to indicate the suspicious banknote, the conveyance unit 240 may convey the banknote to the discharge unit 222 (step 446).

After that, the control unit 290 may determine whether there are any banknotes that have been placed on the deposit unit 221 but have not been taken in (step 447). If it is determined at step 447 that there are one or more banknotes that have been placed but not taken in, the control unit 290 may return the process to step 441. On the other hand, if it is determined at step 447 that there are no banknotes that have been placed but not yet taken in, that is, if it is determined that all placed banknotes have been taken in, the control unit 290 may determine whether one or more banknotes are stacked in the discharge unit 222 (step 448).

If it is determined at step 448 that one or more banknote are stacked in the discharge unit 222, the control unit 290 may print the forcible storage information based on the discrimination result at step 443 on paper or an envelope (step 449). For example, the control unit 290 may print the forcible storage information using the printer 22f. Also, the control unit 290 may prompt a user to put the one or more banknotes stacked in the discharge unit 222 in the envelope and store the envelope in the storage unit 21e of the drop box 2e (step 450). For example, if the forcible storage information is printed on the paper, the control unit 290 may display a message on the display input unit 21f prompting the user to put the paper and the one or more banknotes stacked in the discharge unit 222 in the envelope and store the envelope in the storage unit 21e. If the forcible storage information is printed on the envelope, the control unit 290 may display a message on the display input unit 21f prompting the user to put the one or more banknotes stacked in the discharge unit 222 in the envelope and store the envelope in the storage unit 21e. In such a case, the control unit 290 may use LEDs or other means to inform the user of the location of the storage unit 21e of the drop box 2e where the envelope is to be stored. This causes the user to store the suspicious banknote in the envelope in the storage unit 21e of the drop box 2e with the forcible storage information clearly indicated without any user action.

The control unit 290 may now determine whether all suspicious banknotes stacked in the discharge unit 222 have been removed by the user (step 451). If it is not determined at step 451 that all suspicious banknotes have been removed, the control unit 290 repeats step 451. On the other hand, if it is determined at step 451 that all suspicious banknotes have been removed, the conveyance unit 240 may store banknotes discriminated as the true banknotes in any of the plural storage units 231 to 235, and may convey one or more banknotes discriminated as the damaged banknotes to the discharge unit 222, among banknotes stored in the temporary storage unit 224 (step 452). Even if it is not determined at step 448 that one or more banknotes are stacked in the discharge unit 222, the conveyance unit 240 may still store banknotes discriminated as the true banknotes in any of the plural storage units 231 to 235, and may convey one or more banknotes discriminated as the damaged banknotes to the discharge unit 222, among banknotes stored in the temporary storage unit 224 (step 452). Here, it may be determined whether each banknote stored in the temporary storage unit 224 is the true banknote or the suspicious banknote based on the symbolic code number read from each banknote by the discrimination sensor 225. The damaged banknotes conveyed to the discharge unit 222 at step 452 may be stored in the storage unit 21e of the drop box 2e. Information about the true banknotes, information about the damaged banknotes, and information about the suspicious banknotes obtained by the process described in FIG. 10 are linked as related to the same transaction and stored in the memory (not shown). Then, the control unit 290 may terminate the process.

In the above, banknotes discriminated as the suspicious banknotes are put in an envelope and stored in any of the plural storage units 231 to 235, but banknotes discriminated as the damaged banknotes or the suspicious banknotes may be put in an envelope and stored in any of the plural storage units 231 to 235. This can result in the envelope containing no suspicious banknotes. For such cases, envelopes containing any suspicious banknotes may be made different from those containing no suspicious banknotes. Methods for differentiating envelopes may include a method of using visually different envelopes, a method of attaching codes to the envelopes to distinguish them, and the like.

What is claimed is:

1. A method for processing banknote, the method comprising:
conveying, by a conveyor, the banknote taken in from an intake port;
discriminating, by a discrimination sensor, whether the banknote conveyed by the conveyor is first banknote or second banknote, the first banknote being to be stored in at least one storage, the second banknote being to be forcibly stored in the at least one storage; and
performing, by a controller, output processing to output forcible storage information used in forcible storage of the second banknote, the forcible storage information being output without user intervention.

2. The method of claim 1, wherein the forcible storage information is based on a discrimination result of the second banknote by the discrimination sensor.

3. The method of claim 1, wherein the output processing includes printing, by a printer, the forcible storage information on a sheet of paper, the sheet of paper and the second banknote being to be enclosed in an envelope, the envelope being to be stored in the at least one storage.

4. The method of claim 1, wherein the output processing includes printing, by a printer, the forcible storage information on an envelope, the envelope being to enclose the second banknote and being to be stored in the at least one storage.

5. The method of claim 1, wherein the forcible storage information includes at least one of information identifying a transaction related to the banknote, information identifying a user performing the transaction, a number of sheets of the banknote, a currency type of the banknote, a denomination of the banknote, a symbolic code number of the banknote, and information indicating that the forcible storage is performed in the transaction.

6. The method of claim 1, wherein
the method is performed in one apparatus, the one apparatus including the intake port, the conveyor, the discrimination sensor, a discharge port, and one storage of the at least one storage,
the output processing is performed in response to the first banknote being stored in the one storage and the second banknote being discharged to the discharge port, and
the second banknote is stored in the one storage after the output processing is performed.

7. The method of claim 1, wherein
the method is performed with a first apparatus and a second apparatus, the first apparatus including the intake port, the conveyor, the discrimination sensor, a discharge port, and a first storage of the at least one storage, the second apparatus including a second storage of the at least one storage,
the output processing is performed in response to the first banknote being stored in the first storage and the second banknote being discharged to the discharge port, and
the second banknote is stored in the second storage after the output processing is performed.

8. The method of claim 7, wherein
the discharge port includes a first discharge port and a second discharge port,
the second banknote is discriminated, by the discrimination sensor, whether the second banknote is a first category or a second category,
the second banknote as the first category is discharged to the first discharge port, and
the second banknote as the second category is discharged to the second discharge port.

9. The method of claim 7, wherein
the second banknote is discriminated, by the discrimination sensor, whether the second banknote is a first category or a second category, and
the second banknote as the first category is discharged to the discharge port, and then the second banknote as the second category is discharged to the discharge port.

10. The method of claim 9, wherein
the second banknote as the first category includes a damaged banknote in a worse state than the first banknote, and
the second banknote as the second category includes a suspicious banknote which is potentially a counterfeit banknote.

11. The method of claim 9, wherein
the second banknote as the first category includes a suspicious banknote which is potentially a counterfeit banknote, and
the second banknote as the second category includes a damaged banknote in a worse state than the first banknote.

12. The method of claim 7, wherein
the second banknote is enclosed in an envelope,
the envelope is stored in the second storage, and
the second apparatus is contained within, adjacent to, or separate from the first apparatus.

13. The method of claim 1, wherein the second banknote does not include a damaged banknote in a worse state than the first banknote, and includes a suspicious banknote which is potentially counterfeit banknote.

14. The method of claim 1, wherein the second banknote includes a damaged banknote in a worse state than the first banknote, and a suspicious banknote which is potentially counterfeit banknote.

15. An apparatus for processing banknote, the apparatus comprising:
a conveyor for conveying the banknote taken in from an intake port;
a discrimination sensor for discriminating whether the banknote conveyed by the conveyor is first banknote or second banknote, the first banknote being to be stored in at least one storage, the second banknote being to be forcibly stored in the at least one storage; and
a controller for performing output processing to output forcible storage information used in forcible storage of the second banknote, the forcible storage information being output without user intervention.

16. The apparatus of claim 15, further comprising the intake port, a discharge port, and one storage of the at least one storage, wherein
the output processing is performed in response to the first banknote being stored in the one storage and the second banknote being discharged to the discharge port, and
the second banknote is stored in the one storage after the output processing is performed.

17. The apparatus of claim 15, further comprising the intake port, a discharge port, a first storage of the at least one storage, and a second storage of the at least one storage, wherein
the output processing is performed in response to the first banknote being stored in the first storage and the second banknote being discharged to the discharge port, and
the second banknote is stored in the second storage after the output processing is performed.

18. The apparatus of claim 17, wherein
the discharge port includes a first discharge port and a second discharge port,
the second banknote is discriminated, by the discrimination sensor, whether the second banknote is a first category or a second category,
the second banknote as the first category is discharged to the first discharge port, and
the second banknote as the second category is discharged to the second discharge port.

19. The apparatus of claim 17, wherein
the second banknote is discriminated, by the discrimination sensor, whether the second banknote is a first category or a second category, and
the second banknote as the first category is discharged to the discharge port, and then the second banknote as the second category is discharged to the discharge port.
